(19) United States
(12) Patent Application Publication
(10) Pub. No.: US 2004/0117532 A1
(43) Pub. Date: Jun. 17, 2004

(54) Mechanism for controlling external interrupts in a virtual machine system

(76) Inventors: Steven M. Bennett, Hillsboro, OR (US); Michael Kozuch, Export, PA (US); Gilbert Neiger, Portland, OR (US); Erik Cota-Robles, Portland, OR (US); Stalinselvaraj Jeyasingh, Portland, OR (US); Alain Kagi, Portland, OR (US); Richard Uhlig, Hillsboro, OR (US)

Correspondence Address: Marina Portnova, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/318,248

(22) Filed: Dec. 11, 2002

(51) Int. Cl. G06F 13/24

(52) U.S. Cl. 710/260

(57) ABSTRACT

In one embodiment, an occurrence of an interrupt is identified during the operation of guest software. Further, a determination is made as to whether the interrupt is managed by guest software. The determination depends on the current value of an interrupt control indicator. If the interrupt is not managed by guest software, control is transitioned to a virtual machine monitor (VMM) if the VMM is ready to receive control.

### BACKGROUND OF THE INVENTION

In a typical computer system, devices request services from system software by generating interrupt requests, which are propagated to an interrupt controller via multiple interrupt request lines. Once the interrupt controller identifies an active interrupt request line, it sends an interrupt signal to the processor. In response, the interrupt controller interface logic on the processor determines whether the software is ready to receive the interrupt. If the software is not ready to receive the interrupt, the interrupt is held in a pending state until the software becomes ready. Once the software is determined to be ready, the interrupt controller interface logic requests the interrupt controller to report which of the pending interrupts is highest priority. The interrupt controller prioritizes among the various interrupt request lines and identifies the highest priority interrupt request to the processor which then transfers control flow to the code that handles that interrupt request.

In a conventional operating system (OS), all the interrupts are controlled by a single entity known as an OS kernel. In a virtual machine system, a virtual-machine monitor (VMM) should have ultimate control over various operations and events occurring in the system to provide proper operation of virtual machines and for protection from and between virtual machines. To achieve this, the VMM typically receives control when guest software accesses a hardware resource or causes an occurrence of a certain event such as an interrupt or an exception. Accordingly, in a virtual machine system, the interrupts are typically controlled by the VMM.

In particular, when operations in virtual machines supported by the VMM cause system devices to generate interrupts, the VMM intercedes between the virtual machine and the interrupt controller. That is, when an interrupt signal is raised, the currently running virtual machine is interrupted and control of the processor is passed to the VMM. The VMM then receives the interrupt, executes any necessary operations for the interrupt controller, and handles the interrupt or delivers the interrupt to the appropriate virtual machine.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates one embodiment of a virtual-machine environment, in which the present invention may operate;

FIG. 2 is a block diagram of one embodiment of a system for processing interrupts in a virtual machine environment;

FIG. 3 is a flow diagram of one embodiment of a process for handling interrupts in a virtual machine system;

FIG. 4 is a block diagram illustrating the processing of interrupts in a virtual machine system having a preferred virtual machine, according to one embodiment of the present invention;

FIG. 5 is a flow diagram of one embodiment of a process for handling interrupts occurring during operation of a non-preferred virtual machine; and

FIG. 6 is a flow diagram of one embodiment of a process for handling interrupts in a virtual machine system without a preferred virtual machine.

### DESCRIPTION OF EMBODIMENTS

A method and apparatus for controlling external interrupts in a virtual machine system are described. In the following description, for purposes of explanation, numerous specific details are set forth in order to provide a thorough understanding of the present invention. It will be apparent, however, to one skilled in the art that the present invention can be practiced without these specific details.

Some portions of the detailed descriptions that follow are presented in terms of algorithms and symbolic representations of operations on data bits within a computer system's registers or memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer-system memories or registers or other such information storage, transmission or display devices.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

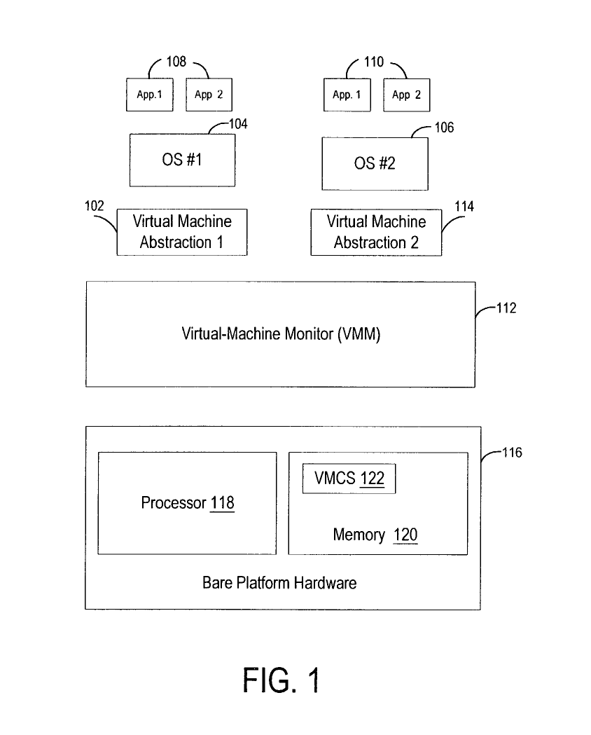

FIG. 1 illustrates one embodiment of a virtual-machine environment 100, in which the present invention may operate. In this embodiment, bare platform hardware 116 comprises a computing platform, which may be capable, for example, of executing a standard operating system (OS) or a virtual-machine monitor (VMM), such as a VMM 112. The VMM 112, though typically implemented in software, may emulate and export a bare machine interface to higher level software. Such higher level software may comprise a standard or real-time OS, may be a highly stripped down operating environment with limited operating system functionality, may not include traditional OS facilities, etc. Alternatively, for example, the VMM 112 may be run within, or on top of, another VMM. VMMs and their typical features and functionality are well-known by those skilled in the art and may be implemented, for example, in hardware, software, firmware or by a combination of various techniques.

The platform hardware 116 can be of a personal computer (PC), mainframe, handheld device, portable computer, set-top box, or any other computing system. The platform hardware 116 includes a processor 118 and memory 120.

Processor 118 can be any type of processor capable of executing software, such as a microprocessor, digital signal processor, microcontroller, or the like. The processor 118 may include microcode, programmable logic or hardcoded logic for performing the execution of method embodiments of the present invention. Though FIG. 1 shows only one such processor 118, there may be one or more processors in the system.

Memory 120 can be a hard disk, a floppy disk, random access memory (RAM), read only memory (ROM), flash memory, any combination of the above devices, or any other type of machine medium readable by processor 118. Memory 120 may store instructions and/or data for performing the execution of method embodiments of the present invention.

The VMM 112 presents to other software (i.e., “guest” software) the abstraction of one or more virtual machines (VMs), which may provide the same or different abstractions to the various guests. FIG. 1 shows two VMs, 102 and 114. The guest software running on each VM may include a guest OS such as a guest OS 104 or 106 and various guest software applications 108 and 110. Each of the guest OSs 104 and 106 expects to access physical resources (e.g., processor registers, memory and I/O devices) within the VMs 102 and 114 on which the guest OS 104 or 106 is running and to handle various events including interrupts generated by system devices during the operation of the VMs 102 and 114.

In one embodiment, an interrupt generated during the operation of the VM 102 or 114 may either be classified as a “privileged” event or a “non-privileged” event. For privileged events, the VMM 112 facilitates functionality desired by guest software while retaining ultimate control over these privileged events. Non-privileged events do not need to be handled by the VMM 112 and are controlled by guest software.

In one embodiment, the interrupts are classified as privileged or non-privileged based on a current value of an interrupt control indicator. The interrupt control indicator specifies whether guest software or the VMM 112 manages an interrupt.

In one embodiment, a single interrupt control indicator (e.g., a single bit) is used for all interrupts. In another embodiment, a separate interrupt control indicator is used for each interrupt type (e.g., an interrupt number). For example, in the instruction set architecture (ISA) of the Pentium IV (hereafter referred to as the IA-32 ISA), there may be 256 interrupt control indicators (i.e., 256 bits), one for each possible maskable hardware interrupt type. In yet other embodiments, separate interrupt control indicators may be used for groups of interrupt types or for any other combination of interrupts.

The interrupt control indicator(s) cannot typically be accessed and/or modified by the VMs 102 and 114. In one embodiment, the VMM 112 sets the value(s) of the interrupt control indicator(s) before transferring control to the VM 102 or 114. Alternatively, each of the VMs 102 and 114 is associated with a different (set of) interrupt control indicator(s) that is (are) set to a predefined value(s).

In one embodiment, the one or more interrupt control indicators are stored in a virtual machine control structure (VMCS) 122, which may reside in memory 120 (as shown in FIG. 1) or, alternatively, in the processor 118, a combination of the memory 120 and the processor 118, or in any other storage location or locations. Different guest software may be controlled using data from different VMCS images, though only one such VMCS is shown in FIG. 1. It should be noted that any other data structure (e.g., an on-chip cache, a file, a lookup table, etc.) may be used to store the interrupt control indicator (s) without loss of generality. The interrupt control indicator(s) may be a bit field in a control vector, or may be a bit or bitmap stored in a distinct field of the VMCS.

Alternatively, in an embodiment, the one or more interrupt control indicators are stored in one or more machine registers or in memory 120.

If an interrupt is generated during the operation of guest software, the appropriate interrupt control indicator is consulted to determine whether the interrupt is to be managed by guest software. If the determination is positive, the interrupt will be managed by guest software. Otherwise, the interrupt will be managed by the VMM 112.

In one embodiment, if the interrupt is to be managed by the VMM 112, control is transferred to the VMM 112. The transfer of control between the VM 102 or 104 and the VMM 112 is achieved via any mechanism known in the art. Handling of an interrupt after control is transferred to the VMM 112 will be described in more detail below.

In one embodiment, if the interrupt is to be managed by the guest software, control remains with the guest software. The interrupt will be delivered to the guest software if the currently executing software is ready to receive interrupts, as will be discussed in greater detail below.

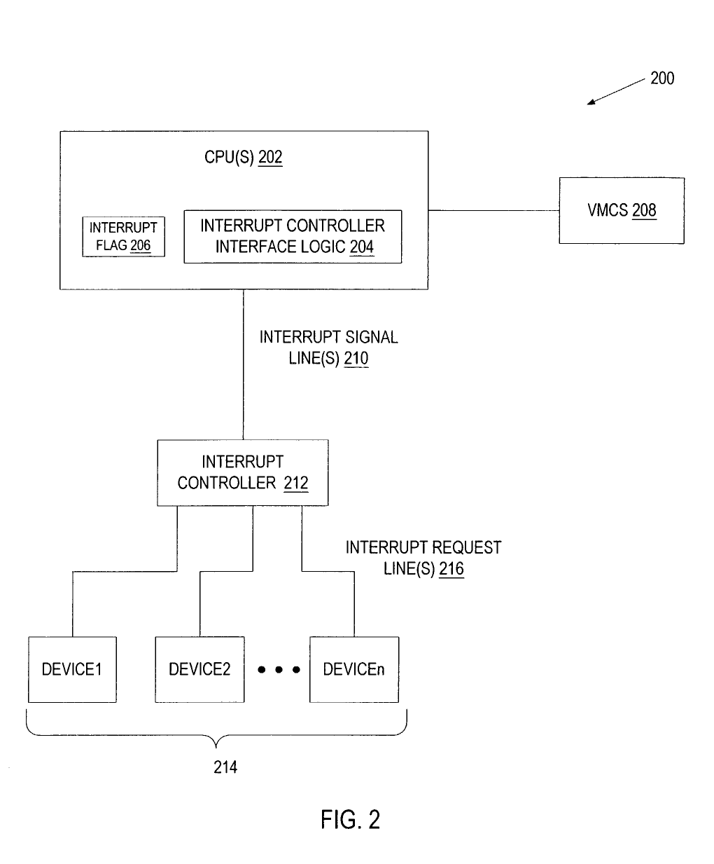

FIG. 2 is a block diagram of one embodiment of a system 200 for processing interrupts in a virtual machine environment.

Referring to FIG. 2, devices 214 (e.g., I/O devices) request services from system software by generating interrupt requests, which are propagated to an interrupt controller 212 via one or more interrupt request lines 216. Once the interrupt controller 212 identifies an active interrupt request line 210, it sends an interrupt signal 210 to the CPU 202. In an embodiment, there may be more than one interrupt signal line 210 to the CPU 202, or, alternatively, the interrupt “signal” may be delivered via a bus message or through any other communication mechanism or protocol.

In response to an active interrupt signal 210 from the interrupt controller 212, an interrupt controller interface logic 204 determines which software has control over the interrupt. If the interrupt occurs during the operation of VMM, the interrupt is managed by the VMM unconditionally. Alternatively, if the operation occurs during the operation of guest software, the interrupt controller interface logic 204 determines whether guest software or the VMM manages the interrupt.

This determination depends on the current value of an interrupt control indicator stored, in an embodiment, in VMCS 208. The interrupt control indicator specifies whether guest software or the VMM manages the interrupt. As discussed above, one or more interrupt control indicators may be used for the interrupts. If more than one control indicator is used, then a specific interrupt control indicator associated with the interrupt being processed is accessed.

If the interrupt control indicator specifies that the interrupt is to be managed by guest software, the interrupt controller interface logic 204 further determines whether guest software is ready to receive interrupts. In one embodiment, the interrupt controller interface logic 204 makes this determination upon consulting an interrupt flag 206 that can be updated by guest software when the state of guest software's ability to accept interrupts changes. For example, in the IA-32 ISA, the EFLAGS register contains the IF interrupt flag bit, which, in part, controls whether an interrupt will be delivered to the software (other factors may block interrupts in the IA-32 ISA and these factors must be considered in determining if an interrupt may be delivered). The interrupt flag 206 resides in the CPU 202 outside or inside the interrupt controller interface logic 204. Alternatively, any other mechanism known in the art can be used to determine whether guest software is ready to accept interrupts.

If the interrupt controller interface logic 204 determines that guest software is ready to receive the interrupt, it requests that the interrupt controller 212 identify which of the pending interrupts is highest priority and delivers the highest priority interrupt to guest software, thus causing control flow to transfer to the beginning of the interrupt handling code associated with guest software. Otherwise, if guest software is not currently ready to receive interrupts, the interrupt is held in a pending state until guest software becomes ready.

If the interrupt control indicator specifies that the VMM manages the interrupt, then, in one embodiment, the interrupt controller interface logic 204 triggers the transition of control to the VMM.

In another embodiment, the transition of control to the VMM is conditioned on a current value of an interrupt transition flag referred to herein as a monitor interrupt flag (MIF). That is, the interrupt controller interface logic 204 first examines the current value of the MIF to determine whether the arrival of the interrupt managed by the VMM should cause the transfer of control to the VMM. The MIF behaves in a manner that is analogous to the interrupt flag 206, indicating whether interrupts are allowed to cause transitions to the VMM. In an embodiment, the MIF resides in the VMCS 208 and is controlled by the VMM. In another embodiment, the MIF resides in a machine register or in memory. If the MIF does not require a transfer of control, the interrupt will be held pending and no transfer of control will occur. Otherwise, the interrupt controller interface logic 204 will trigger the transfer of control to the VMM.

In one embodiment, multiple MIFs are maintained for interrupts with different characteristics, and a MIF to be used for a specific interrupt is selected from these MIFs based on characteristics of the interrupt.

When transfer of control to the VMM is required, in one embodiment, the interrupt is held pending at the interrupt controller 212 following the transfer of control to the VMM. In this embodiment, the identity of the interrupt source (e.g., referred to as a vector in the IA-32 ISA) that, in part, identifies the device generating the interrupt, may not be known to the VMM at the time immediately following the transfer of control. As part of the transfer of control, the processor clears the interrupt flag 206 which is active after the transfer. Following the transfer of control, the VMM may use the interrupt flag 206 to enable interrupts and have the interrupt delivered. The VMM may determine the vector of the pending interrupt using any mechanism known in the art. For example, in the IA32 ISA, each distinct interrupt vector is handled by a unique interrupt handler, thus identifying the interrupt vector when the interrupt is delivered to the VMM.

In another embodiment, the identity of the interrupt source is known at the interrupt controller 212 before the transfer of control to the VMM. In this embodiment, the interrupt may be delivered to the VMM with data specifying the identity of the interrupt source. For example, the data may be delivered in a field in the VMCS.

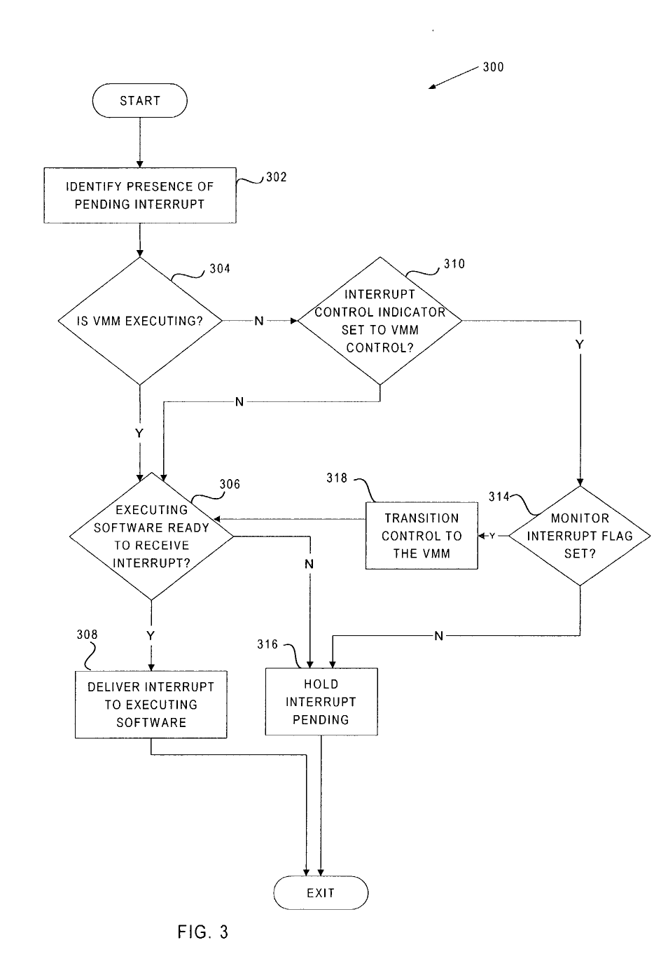

FIG. 3 is a flow diagram of one embodiment of a process 300 for handling interrupts in a virtual machine system. The process may be performed by processing logic that may comprise hardware (e.g., circuitry, dedicated logic, programmable logic, microcode, etc.), software (such as run on a general purpose computer system or a dedicated machine), or a combination of both.

Referring to FIG. 3, process 300 begins with processing logic identifying the presence of a pending interrupt (processing block 302) and determining whether the interrupt has occurred during the operation of the VMM or guest software (decision box 304).

If the interrupt occurs during the operation of the VMM, processing logic determines whether the VMM is ready to receive interrupts (decision block 306). If the determination is positive, processing logic delivers the interrupt to the VMM (processing block 308). If the determination is negative, processing logic does not deliver the interrupt to the VMM, leaving the interrupt pending (processing block 316). In one embodiment, processing logic uses a current setting of an interrupt flag (e.g., an interrupt flag referred to as EFLAGS.IF in the IA-32 ISA) to determine whether the VMM is ready to receive interrupts.

If the determination made at decision box 304 is negative, i.e., the interrupt has occurred during the operation of guest software, processing logic further determines whether guest software is managing the interrupt (decision box 310). This determination depends on an interrupt control indicator. In one embodiment, the interrupt control indicator is set by the VMM each time the VMM transfers control to guest software. As discussed above, there may be one or more interrupt control indicators, the selection of a particular interrupt control indicator determined by the interrupt vector or other criteria. In an embodiment, each virtual machine has a separate interrupt control indicator. If more than one interrupt control indicator is used, an interrupt control indicator associated with the interrupt being processed is accessed.

If the interrupt control indicator specifies that guest software is managing the interrupt, processing logic attempts to deliver the interrupt to guest software by executing processing blocks 306, 308 and 316 as described above.

In one embodiment, if the interrupt control indicator specifies that guest software is not managing the interrupt, processing logic consults an interrupt transition flag referred to herein as a monitor interrupt flag (MIF) and makes a decision based on its contents (decision box 314). If the MIF indicates that the VMM is not ready to receive control transfers due to interrupts, then the interrupt is held pending (processing block 316) and control remains with guest software. Otherwise, processing logic transitions control to the VMM (processing block 318).

In another embodiment (not shown), the MIF is not used, and transfer of control occurs unconditionally upon determining that the interrupt is managed by the VMM.

During the transfer of control to the VMM, the interrupt flag may be set to a predefined value, left unmodified, or updated according to some other mechanism. Following the transfer of control to the VMM, processing logic executes processing blocks 306, 308 and 316 as discussed above.

As discussed above, following the transfer of control to the VMM (processing block 318), the interrupt may be held pending at the interrupt controller. If the identity of the interrupt source is known, processing logic may attempt to deliver the interrupt to the VMM with data specifying the source of the interrupt.

In one embodiment, if the interrupt is held pending at the interrupt controller following the transfer of control to the VMM, the VMM updates the interrupt flag when it becomes ready to receive interrupts. Processing logic then delivers the interrupt to the VMM. The VMM may then handle the interrupt itself. Alternatively, the VMM may evaluate the nature of the interrupt to determine which virtual machine is designated to handle this interrupt, emulate the delivery of the interrupt to the designated virtual machine and transition control to the designated virtual machine, as will be discussed in greater detail below.

In another embodiment (not shown), processing logic does not deliver the interrupt to the VMM. Instead, processing logic provides information about the interrupt to the VMM (e.g., either in response to a VMM request or as part of information passed to the VMM when transitioning control to the VMM). Based on this information, the VMM determines which virtual machine is designated to handle this interrupt and either transfers control to this virtual machine (where the interrupt will be delivered as discussed above) or emulates the delivery of the interrupt to the virtual machine and then transfers control to the virtual machine.

Note that while an interrupt is pending, process 300 will be continually repeated until the interrupt is delivered to the VMM or the guest software, or the interrupt is no longer pending.

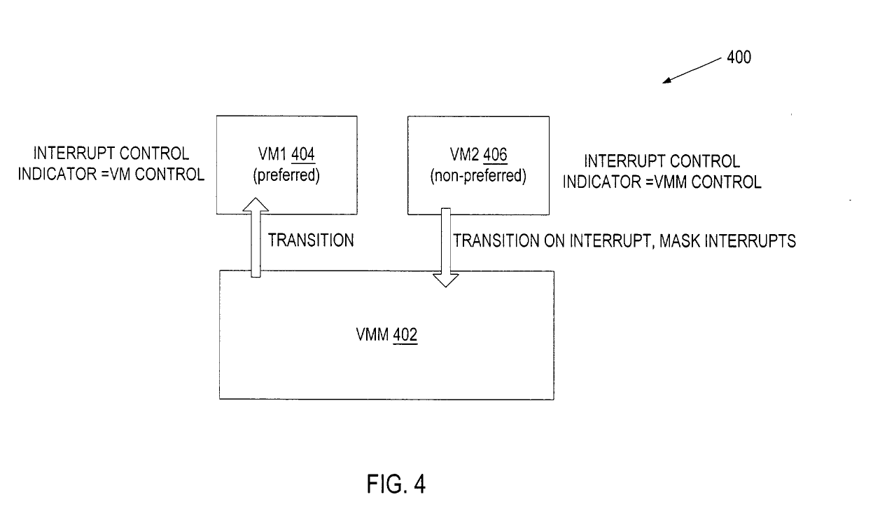

In one embodiment, a virtual machine system includes a preferred virtual machine and one or more non-preferred virtual machines. The preferred virtual machine is designated to handle all the interrupts generated by system devices. The non-preferred virtual machines are designated to perform operations other than interrupt handling (e.g., various computations, encryptions, decryptions, etc.). FIG. 4 is a block diagram illustrating the processing of interrupts in a virtual machine system having a preferred virtual machine, according to one embodiment of the present invention.

Referring to FIG. 4, VM1 404 is a preferred virtual machine that manages all interrupts in the system 400. VM2 406 is a non-preferred virtual machine that manages operations that do not involve processing of interrupts within the system 400. Although FIG. 4 shows only a single non-preferred VM (e.g., VM2 406), there may be more than one non-preferred VM present in the system. VMM 402 knows that VM1 404 is the preferred virtual machine. When transferring control to VM1 404, VMM 402 sets an interrupt control indicator (or each of multiple interrupt control indicators) to a value indicating that VM1 404 manages all interrupts. Subsequently, when an interrupt occurs during the operation of VM1 404, the interrupt controller interface logic consults the appropriate interrupt control indicator, determines that the interrupt is managed by VM1 404, and delivers the interrupt to VM1 404 when VM1 404 is ready to receive interrupts.

When transferring control to VM2 406, VMM 402 sets the interrupt control indicator (or each of multiple interrupt control indicators) to a value indicating that VM2 406 does not manage any interrupts. Subsequently, when an interrupt occurs during the operation of VM2 406, the interrupt controller interface logic consults the appropriate interrupt control indicator, determines that VM2 406 does not manage the interrupt, and triggers the transfer of control to VMM 402. In addition, in an embodiment, during the transition of control to the VMM 402, the interrupt controller interface logic sets the interrupt flag to a value indicating that all the interrupts are masked (e.g., setting the interrupt flag to 0), thus preventing delivery of interrupts to VMM 402. In another embodiment, the interrupt flag may be set to a predefined value or to a value read from a virtual machine control structure (VMCS).

When control is transitioned to VMM 402, VMM 402 is notified that the cause of this transfer is a pending interrupt. VMM 402, knowing that all the interrupts are to be handled by VM1 404, modifies the interrupt control indicator(s) to allow VM1 404 to manage all interrupts and transfers control to VM1 404. If, after VM1 404 receives control, the interrupt flag indicates that VM1 404 is ready to receive interrupts, the interrupt controller interface logic will retrieve the highest priority interrupt from the interrupt controller and deliver the highest priority interrupt to VM1 404. Otherwise, VM1 404 will update the interrupt flag as soon as it becomes ready to receive interrupts. When VM1 404 is ready to receive interrupts, the interrupt controller interface logic will retrieve the highest priority interrupt from the controller, and deliver the highest priority interrupt to VM1 404.

In another embodiment, a monitor interrupt flag (MIF) is consulted before transitioning control to the VMM from VM2 406, as discussed above in conjunction with FIG. 3.

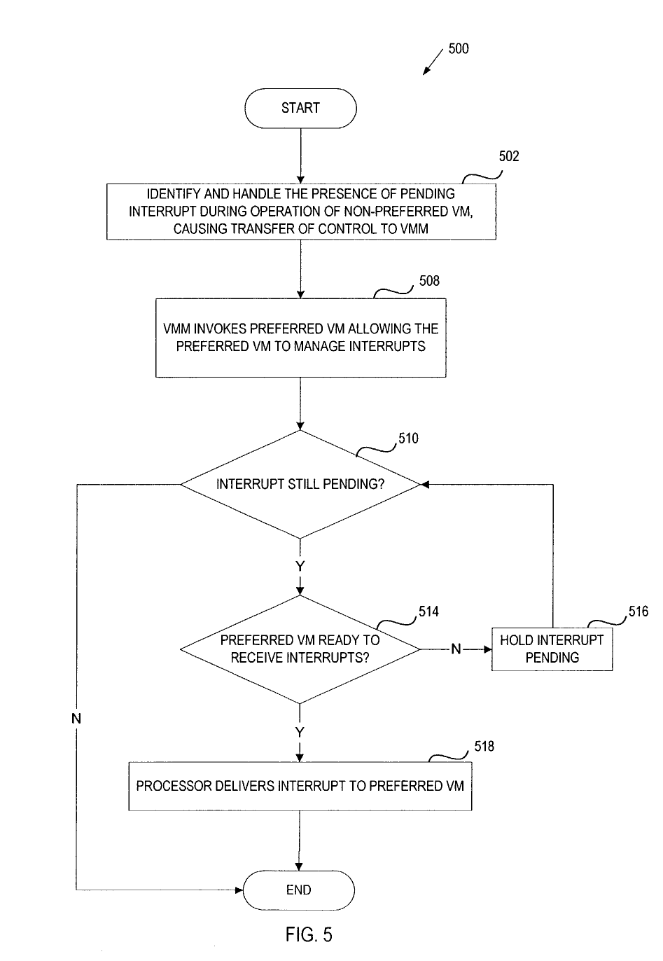

FIG. 5 is a flow diagram of one embodiment of a process 500 for handling interrupts occurring during operation of a non-preferred virtual machine. The process may be performed by processing logic that may comprise hardware (e.g., circuitry, dedicated logic, programmable logic, microcode, etc.), software (such as run on a general purpose computer system or a dedicated machine), or a combination of both.

Referring to FIG. 5, process 500 begins with processing logic identifying and handling the presence of a pending interrupt during the operation of a non-preferred virtual machine (e.g., as illustrated in FIG. 3), causing a transfer of control to the VMM (processing block 502). Next, the VMM invokes the preferred virtual machine and sets the interrupt control indicator to a value that permits the preferred virtual machine to manage interrupts (processing block 508).

After the preferred VM is invoked, if the interrupt is still pending (block 510), processing logic makes a determination as to whether the preferred virtual machine is ready to receive interrupts (i.e., consults the interrupt flag and/or other machine state to determine whether it indicates that interrupts are unmasked) (decision box 514). If this determination is positive, processing logic delivers the interrupt to guest software (processing block 518). If the guest is not ready to receive interrupts, the interrupt is held pending (processing block 516) and the evaluation of readiness is repeated (returning to processing block 510).

In one embodiment, the VMM does not unmask interrupts at any time (i.e., it does not change the interrupt flag to indicate that it may accept interrupts). In another embodiment (not shown), a VMM may unmask interrupts. If an interrupt is pending when the VMM is executing and the interrupt is not masked by the interrupt flag, the interrupt will be delivered to the VMM. The VMM emulates the delivery of the interrupt to the preferred VM when it is ready to receive interrupts and transfers control to the preferred VM.

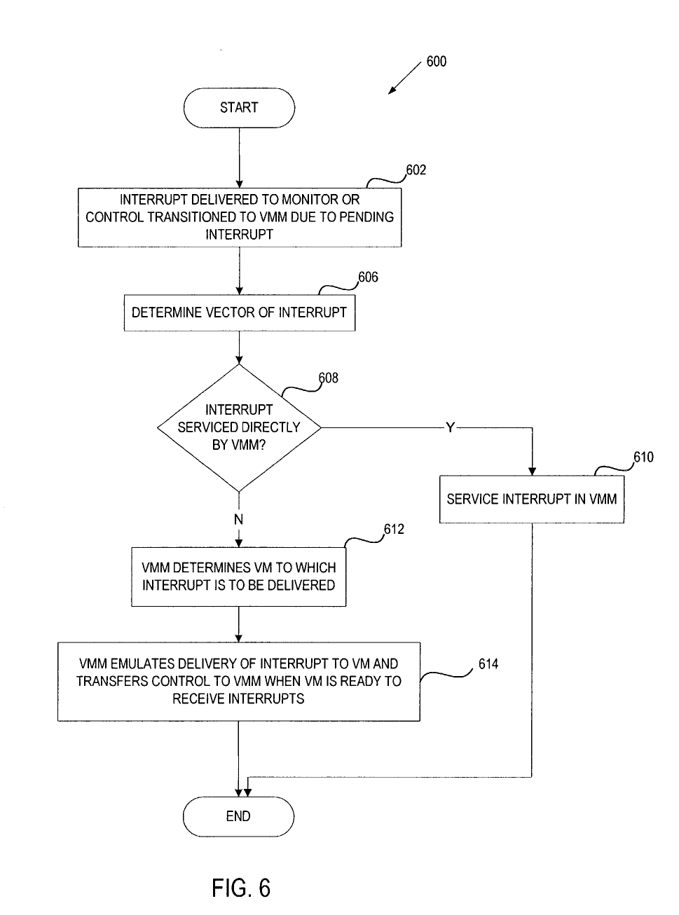

FIG. 6 is a flow diagram of one embodiment of a process 600 for handling interrupts in a virtual machine system where interrupts may be handled by more than one virtual machine or by the VMM. The process may be performed by processing logic that may comprise hardware (e.g., circuitry, dedicated logic, programmable logic, microcode, etc.), software (such as run on a general purpose computer system or a dedicated machine), or a combination of both.

Referring to FIG. 6, process 600 begins after processing logic (in processing block 602) has either delivered the interrupt to the VMM (e.g., as in processing block 308 of FIG. 3) or transitioned control to the VMM due to the pending interrupt (e.g., as in processing block 318 of FIG. 3).

Next, processing logic in the VMM determines the identity of the interrupt source (processing block 606). For example, in one embodiment, the VMM may perform various memory or input-output operations to obtain the identity of the interrupt source (e.g., a vector) from the interrupt controller or input/output devices. In other embodiments in which the interrupt is held pending at the interrupt controller following the transition to the VMM due to a pending interrupt, the VMM may unmask interrupts, allowing the processor to deliver the interrupt to the VMM. The delivery of the interrupt to the VMM may provide information regarding the source of the interrupt as discussed above (e.g., the interrupt handler to which the interrupt is delivered may determine the interrupt source in the IA-32 ISA). That is, when the interrupt is delivered to the VMM or control is transitioned to the VMM from the guest software due to a pending interrupt, the VMM may specify that this interrupt needs to be processed by a particular virtual machine.

Next, the VMM determines if the interrupt is to be handled directly by the VMM (processing block 608). This determination may depend on whether the interrupt has originated from a device managed by the VMM or a virtual machine (e.g., the VMM may manage hard drives of all virtual machines while a video capture card may be managed by a specific virtual machine). If the determination made at decision box 608 is positive, the VMM services the interrupt (processing block 610) and process 600 ends.

If the determination in processing block 608 is negative, the VMM determines which virtual machine should service the interrupt (processing block 612). Then, when this virtual machine is ready to receive interrupts, the VMM emulates the delivery of the interrupt to the virtual machine and transitions control to the virtual machine (processing block 614).

Thus, a method and apparatus for handling interrupts in a virtual machine system have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
recognizing a pending interrupt during an operation of guest software;
determining whether the interrupt is managed by the guest software if the interrupt is not managed by the guest software,
determining whether a virtual machine monitor (VMM) is ready to receive control; and
transitioning control to the VMM if the VMM is ready to receive control.

2. The method of claim 1 wherein determining whether the interrupt is managed by the guest software further comprises:
reading an interrupt control indicator associated with the interrupt.

3. The method of claim 2 wherein the interrupt control indicator is stored in at least one of a virtual machine control structure (VMCS), a machine register and memory.

4 The method of claim 2 wherein the interrupt control indicator is selected from a plurality of interrupt control indicators based on characteristics of the interrupt.

5. The method of claim 1 further comprising:
determining that the interrupt is managed by the guest software.

6. The method of claim 5 further comprising:
determining whether the guest software is ready to receive interrupts, and
delivering the interrupt to the guest software when the guest software is ready to receive interrupts.

7. The method of claim 6 wherein determining whether the guest software is ready to receive interrupts comprises determining a value of an interrupt flag.

8. The method of claim 1 wherein determining whether the monitor is ready to receive control further comprises:
reading an interrupt transition flag.

9. The method of claim 8 wherein the interrupt transition flag is read from at least one of a virtual machine control structure (VMCS), a machine register and memory.

10. The method of claim 8 wherein the interrupt transition flag is selected from a plurality of interrupt transition flags based on characteristics of the interrupt.

11. The method of claim 1 wherein the guest software is associated with a non-preferred virtual machine.

12. The method of claim 11 further comprising:
transitioning control to the VMM;
detecting that a preferred virtual machine is ready to receive interrupts; and
delivering the interrupt to the preferred virtual machine.

13. The method of claim 1 further comprising setting an interrupt flag to one of a value indicating that the VMM is not ready to receive interrupts, a value indicating that the VMM is ready to receive interrupts, and a value read from a virtual machine control structure when transitioning control to the VMM.

14. The method of claim 1 further comprising:
the VMM determining a virtual machine designated to handle the interrupt; and
the VMM emulating delivery of the interrupt to the designated virtual machine if the designated virtual machine is ready to receive interrupts.

15. A system comprising:
an interrupt controller to receive an interrupt from one or more system devices; and
a processor, coupled to the interface controller, to receive a notification of the interrupt from the interrupt controller during an operation of guest software, to determine that the interrupt is not managed by the guest software, and to transfer control to a virtual machine monitor (VMM) if the VMM is ready to receive control.

16. The system of claim 15 further comprising a memory to store the guest software and a virtual machine control structure containing an interrupt control indicator.

17. The system of claim 15 wherein the processor is to determine that the interrupt is managed by the guest software based upon a current value of an interrupt control indicator.

18. The system of claim 17 wherein the processor is to deliver the interrupt to the guest software upon determining that the guest software is ready to receive interrupts.

19. The system of claim 18 wherein the processor is to determine whether the guest software is ready to receive interrupts by consulting a value of an interrupt flag.

20. The system of claim 15 wherein the processor is to determine that the VMM is ready to receive control based on a current value of an interrupt transition flag.

21. The system of claim 15 wherein the guest software is associated with a non-preferred virtual machine.

22. The system of claim 21 wherein the processor is further to transition control to the VMM, and the VMM is to detect that a preferred virtual machine is ready to receive interrupts and to deliver the interrupt to the preferred virtual machine.

23. The system of claim 15 wherein the processor is further to set an interrupt flag to one of a value indicating that the VMM is not ready to receive interrupts, a value indicating that the VMM is ready to receive interrupts, and a value read from a virtual machine control structure when transitioning control to the VMM.

24. The system of claim 15 wherein the VMM is to determine a virtual machine designated to handle the interrupt, and to emulate delivery of the interrupt to the designated virtual machine if the designated virtual machine is ready to receive interrupts.

25. A machine-readable medium containing instructions which, when executed by a processing system, cause the processing system to perform a method, the method comprising:
recognizing a pending interrupt during an operation of guest software;
determining whether the interrupt is managed by the guest software if the interrupt is not managed by the guest software, determining whether a virtual machine monitor (VMM) is ready to receive control; and
transitioning control to the VMM if the VMM is ready to receive control.

26. The machine-readable medium of claim 25 wherein determining whether the interrupt is managed by the guest software further comprises:
reading an interrupt control indicator associated with the interrupt.

27. The machine-readable medium of claim 26 wherein the interrupt control indicator is stored in at least one of a virtual machine control structure (VMCS), a machine register and memory.

28. The machine-readable medium of claim 26 wherein the interrupt control indicator is selected from a plurality of interrupt control indicators based on characteristics of the interrupt.
